(19) United States
(12) Patent Application Publication
(10) Pub. No.: US 2026/0336740 A1
(43) Pub. Date: Oct. 29, 2026

(54) Handlebar Garage Remote Mount

(71) Applicant: BOBBY JUNG RIM, Las Vegas, NV (US)

(72) Inventor: BOBBY JUNG RIM, Las Vegas, NV (US)

(21) Appl. No.: 19/661,274

(22) Filed: Apr. 28, 2026

Related U.S. Application Data
(60) Provisional application No. 63/796,760, filed on Apr. 29, 2025.

(51) Int. Cl. B62J 11/00

(52) U.S. Cl. CPC B62J 11/00

(57) ABSTRACT

A device for mounting a garage door opener on a vehicle handlebar comprises a neodymium magnet-based magnetic attachment member enabling tool-free engagement; an anti-slide housing configured to encase the garage door opener and prevent rearward displacement during vehicle operation; and an arch-shaped mounting base configured to straddle a vehicle handlebar and operatively couple with the magnetic attachment member. A locking element, supported by a lateral connecting arm extending from the magnetic attachment member, engages a selected one of a plurality of adjustment holes defined along an adjustable strap member to secure the device to handlebars of varying diameters. All components interlock without the use of special tools.

### FIELD OF THE INVENTION

The present invention generally relates to accessory devices for vehicles. More specifically, the present invention relates to a device for securely mounting garage door openers on the handlebars of motorcycles, bicycles, and similar vehicles.

### BACKGROUND OF THE INVENTION

Despite the convenience of modern garage door openers, there are several persistent problems associated with mounting these devices securely and safely on vehicles, particularly motorcycles and bicycles. First and foremost, the lack of a reliable attachment mechanism can lead to the accidental detachment of the opener during transit, resulting in damage or loss of the device. Furthermore, many existing mounts fail to account for various handlebar sizes and shapes, making it difficult for users to find an ideal fit without compromising stability.

Additionally, safety concerns arise when the opener is not securely mounted, as it can shift or fall off while the vehicle is in motion, posing risks to both the rider and other road users. Compatibility with different garage door opener models also presents a challenge; many available mounting options do not accommodate the wide variety of devices on the market today, leaving users with limited choices.

Moreover, users face the inconvenience of installation and setup. Traditional mounts often require tools and extended assembly processes. This complexity can deter users from taking full advantage of automated systems designed for effortless operation.

Existing motorcycle garage remote mounts on the market are designed for permanent installation, requiring tools both to mount and remove the remote. No current solution offers a simple, tool-free method for quickly detaching and reattaching the remote.

The present invention addresses this gap by introducing a detachable remote mounting system that enables the rider to remove and reattach the remote without tools. This design offers a meaningful improvement in usability and convenience over conventional fixed-mount alternatives.

Thus, there is a need to develop a device that addresses these mounting problems by providing a secure, versatile, and user-friendly solution to effectively mount garage door openers on vehicles. This new device would enhance user safety, ensure compatibility with multiple opener models, and streamline the installation process, making it accessible for a wider audience of users.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention relates to a mount designed for attaching garage door openers to the handlebars of motorcycles, bicycles, and similar vehicles.

The mount utilizes strong neodymium magnets to securely hold the garage door opener, allowing for easy attachment and removal without the use of special tools. Additionally, it features a housing that prevents the opener from sliding rearward during vehicle operation.

In one aspect, the present invention provides a device comprising a Magnetic Attachment Member, an anti-slide housing, a mounting base, an adjustable strap member, and an interlocking interlocking assembly. The Magnetic Attachment Member employs neodymium magnets to securely retain the garage door opener. The anti-slide housing encases the garage door opener and prevents rearward displacement during operation. The mounting base comprises an arch-shaped body configured to straddle a vehicle handlebar and operatively couple with the Magnetic Attachment Member. The adjustable strap member includes a plurality of holes that cooperate with a locking element to secure the device to handlebars of varying diameters. The interlocking interlocking assembly allows all components to be connected without the need for special tools.

In another aspect, the mounting base includes a locking element supported by a lateral connecting arm, configured to engage a selected one of the plurality of holes in the strap member to fix the device at a desired position on the handlebar.

In a further aspect, the device is constructed from lightweight, durable materials such as high-grade plastic or reinforced composites, providing sufficient strength to withstand vibrations and impacts associated with vehicle operation.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1 shows a perspective view of one embodiment of the device of the present invention with a garage door opener.

FIG. 2 shows an illustration of an exploded view showing the anti-sliding housing, Magnetic Attachment Member and the mounting base of the present invention.

FIG. 3 shows a side view of one embodiment of the device.

FIG. 4 presents a rear side view of one embodiment of the present invention.

FIG. 5 depicts a bottom view of one embodiment of the device of the present invention.

FIG. 6 is an illustration of a bottom perspective view of one embodiment of the present invention.

FIG. 7 is an illustration of one embodiment of the present invention with a locking mechanism and the garage door opener.

FIG. 8 is an illustration of a front view of one embodiment of the present invention.

FIG. 9 is an illustration of a top view of one embodiment of the present invention.

FIG. 10 is an illustration of one embodiment of the mounting bracket with a stopper of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. Any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof.

Additionally, it is important to note that each term used herein refers to that which an ordinary artisan would understand such term to mean based on the contextual use of such term herein. Furthermore, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The present disclosure includes many aspects and features. Moreover, while many aspects and features relate to, and are described in the context of, devices for securely mounting garage door openers on the handlebars of vehicles, embodiments of the present disclosure are not limited to use only in this context.

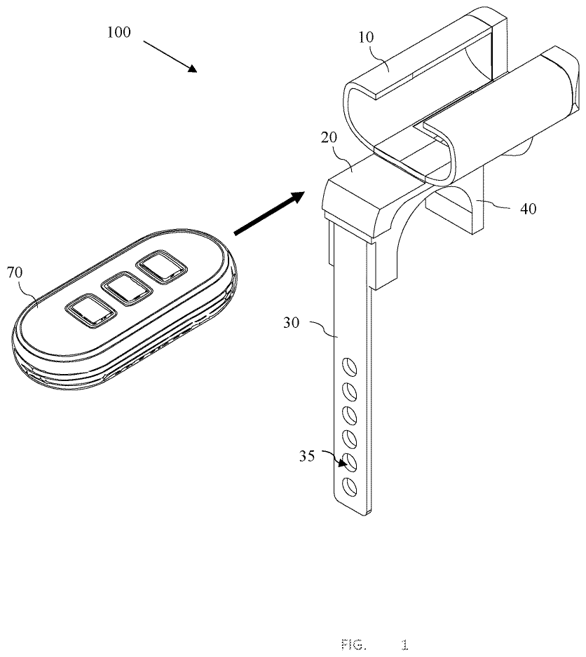

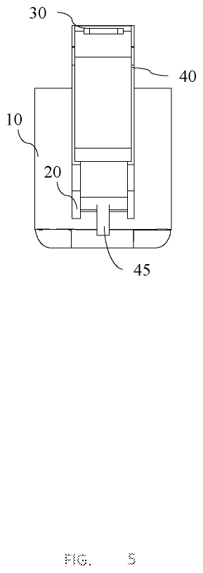

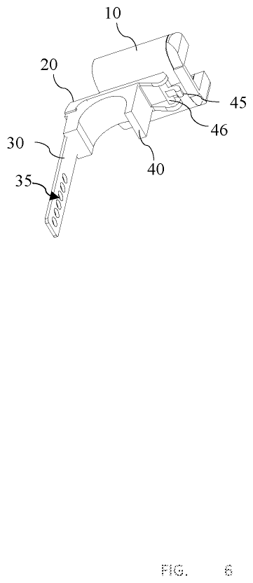

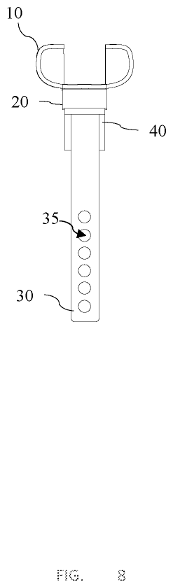

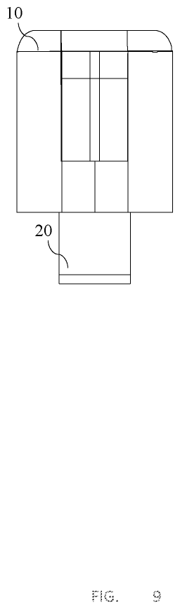

As shown in FIGS. 1-9, the present invention provides a system 100 comprising a magnetic attachment member 20, an anti-slide housing 10, a mounting base 40, and an adjustable strap member 30. Each of these components is described in detail below, along with its structural relationship to the remaining components of the system.

### Magnetic Attachment Member

The magnetic attachment member 20, as shown in FIGS. 1-3 , may serve as the primary retention element of the system, utilizing strong neodymium magnets to securely retain the garage door opener 70 in an operative position on a vehicle handlebar. The magnetic attachment member 20 may include one or more units of magnets. The magnetic attachment member 20 may be operatively coupled to the mounting base 40 and/or an anti-slide housing 10 such that the garage door opener 70 is releasably engageable with the system without the use of specialized tools, thereby facilitating easy, one-handed attachment and removal by the user.

The magnetic retention force provided by the neodymium magnets may be sufficient to maintain the opener (installed in the device of the present invention) in its mounted position during vehicle operation, including under conditions involving mechanical vibration, road irregularities, and rapid directional changes, thereby preventing accidental detachment or displacement of the opener during transit.

In one embodiment, the magnetic attachment member 20 may be configured with adjustable magnet positions to accommodate garage door opener units of varying sizes and form factors, thereby enhancing the versatility and adaptability of the system across a range of opener models.

### Anti-Slide Housing

The anti-slide housing 10, as shown in FIGS. 1-4, may be configured to encase the garage door opener 70, providing a secondary retention structure that works in conjunction with the magnetic attachment member 20 to maintain the positional stability of the opener 70.

The anti-slide housing 10 may be dimensioned and shaped to receive the garage door opener 70 in a closely fitted relationship, thereby preventing rearward sliding or lateral displacement of the opener during vehicle operation or transportation, including under conditions involving bumpy road surfaces or rapid vehicular maneuvers.

In one embodiment, the anti-slide housing 10 may comprise a unitary, elongated rectangular body having a flat bottom wall, two opposing parallel side walls extending perpendicularly upward from opposing longitudinal edges of the flat bottom wall, and an open top face, the flat bottom wall and the two side walls collectively defining an upwardly open U-shaped channel configured to receive and seat the garage door opener 70, wherein outer upper corners of the anti-slide housing 10 are chamfered, and wherein the anti-slide housing 10 is configured to straddle and laterally enclose the garage door opener 70 to prevent rearward displacement of the garage door opener 70;

In such embodiments, the upwardly open U-shaped channel of the anti-slide housing 10 may include a front end having a fully open opening sized to receive and allow the garage door opener 70 to be inserted therethrough, as shown in FIG. 1, and a rear end having a partial opening sized to allow passage of a portion of the garage door opener 70 while providing a blocking wall to stop and retain the garage door opener 70 within the channel.

In some embodiments, the anti-slide housing 10 may include a magnetic attachment member 20 as one structural component. The cooperative engagement between the anti-slide housing and the magnetic attachment member may provide a dual-retention configuration that substantially reduces the risk of opener displacement during use.

In a preferred embodiment, the anti-slide housing 10 may further comprise textured interior surfaces configured to enhance frictional engagement between the housing 10 and the exterior surface of the garage door opener 70, thereby minimizing potential slippage of the opener 70 within the housing 10.

### Mounting Base

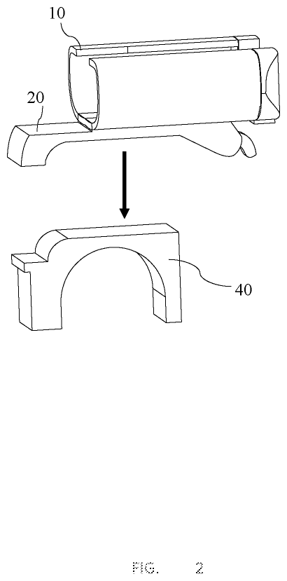

In one embodiment, the mounting base 40 is a rigid, arch-shaped body configured to straddle and clamp around a vehicle handlebar. As best seen in FIG. 2, the mounting base 40 may comprise an inverted U-shaped channel or arch defined by two downward-extending legs and a curved inner surface dimensioned to receive and conform to the outer diameter of a handlebar. The arch geometry distributes clamping force evenly around the handlebar to prevent rotation or displacement under vibration and dynamic riding conditions.

The upper surface of the mounting base 40 may present a substantially flat, curved, arched, or contoured platform or seat that is configured to receive and operatively couple with the magnetic attachment member 20. As shown in FIG. 2, lateral flanges or shoulders may extend from one or more sides of the upper platform, providing positive registration surfaces that engage complementary features on the magnetic attachment member 20 to resist lateral shifting and rotational displacement of the assembled components.

The mounting base 40, the magnetic attachment member 20, and the anti-slide housing 10 are configured to interlock with one another in a stacked assembly without the use of special tools.

In some embodiments, each interface relies on form-fitting geometry —such as the flanged shoulders and mating recesses —combined with the magnetic retention force of the magnetic attachment member 20, such that the entire assembly can be installed and removed by hand. This tool-free interlocking arrangement enables rapid attachment and detachment of an electronic device (e.g., remote control 70) from the handlebar while maintaining positional stability during operation.

### Mounting Bracket

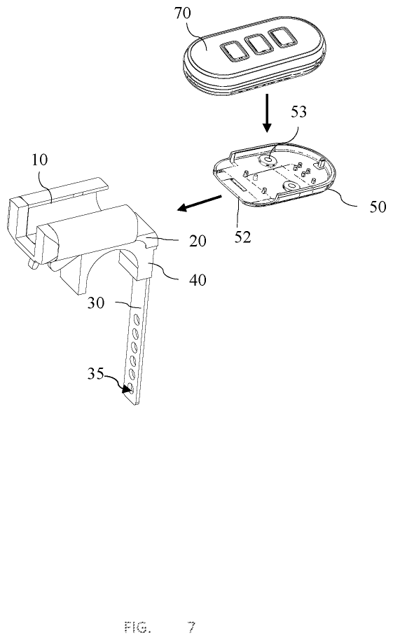

In one embodiment, as shown in FIG. 7, the mounting bracket 50 may be configured as a replacement back-panel component that is installed in lieu of the factory-supplied back panel of the garage door opener 70, wherein the mounting bracket 50 incorporates a magnet 53 that is configured to engage magnetically with the magnetic attachment member 20 or the anti-slip housing 10 and the garage door opener 70, thereby allowing the opener to snap securely into operative engagement with the system. The mounting bracket 50 may be operatively connected to the anti-slip housing 10 such that the magnetic engagement between the two components provides a secure and releasable coupling without requiring mechanical fasteners or tools.

As shown in FIG. 7, in one embodiment, the mounting bracket 50 may comprise an upper section having a U-shaped configuration designed to receive and house the garage door opener 70 in a secure, snug-fitting relationship. The U-shaped inner profile of the mounting bracket 50 may be contoured to correspond to the external geometry of typical garage door opener units, thereby providing a conforming fit that further resists movement of the opener 70 relative to the anti-slip housing 10 during use.

The mounting bracket 50 may be compatible with a plurality of commercially available garage door opener models, including but not limited to the Chamberlain MC100-P2 and the LiftMaster 374UT, thereby enhancing the overall versatility and market applicability of the system.

In some embodiments, the mounting bracket 50 may further comprise customizable brackets configured to extend compatibility to a wider range of garage door opener designs and form factors beyond those explicitly identified herein.

The mounting bracket 50 may further comprise a locking mechanism 52 disposed on a front-facing surface of the mounting bracket 50. The locking mechanism 52 may take the form of an indentation or groove formed in the mounting bracket surface and may be configured to operatively engage a corresponding clip or latch element associated with the garage door opener 70. The cooperative engagement of the groove and the clip or latch element may function to prevent accidental dislodgment of the opener 70 from the mounting bracket 50 during vehicle operation, thereby providing an additional layer of mechanical retention supplemental to the magnetic attachment member 20 and the anti-slide housing 10.

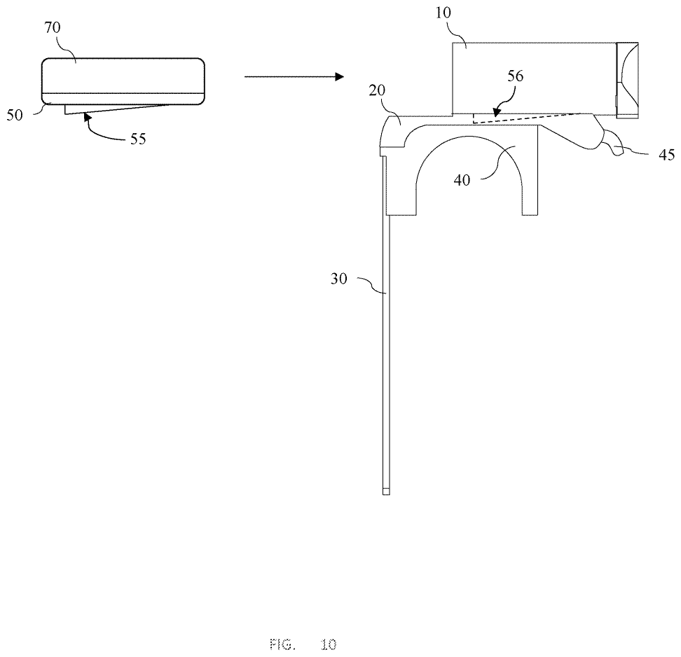

In some embodiments, as shown in FIG. 10, the mounting bracket 50 may incorporate a stopper 55 formed as a slightly protruding element on the front portion, or any suitable area on the bottom, of the mounting bracket 50. The stopper 55 is configured to create a mechanical interference fit between the mounting bracket 50 and the anti-slide housing 10, thereby preventing the garage door opener 70 from unintentionally sliding forward or detaching from the assembled system during normal vehicle operation.

To accommodate the stopper 55, the anti-slide housing 10 and/or the magnetic attachment member 20 may define a corresponding indented area or groove 56 on their interior surface. When the garage door opener 70, fitted with the mounting bracket 50, is inserted into the anti-slide housing 10 in a sliding motion, the stopper 55 travels along the interior channel until it registers with and seats into the indented area 56.

Upon engagement, the stopper 55 and the indented area 56 cooperate to fix the garage door opener 70 in its operative position within the anti-slide housing 10, resisting both forward displacement and lateral movement during vehicle operation, including under conditions involving vibration, road irregularities, and rapid directional changes.

In some embodiments, the stopper 55 may be formed with a triangular cross-sectional profile. The inclined leading face of the triangular stopper 55 allows the mounting bracket 50 to be inserted smoothly into the anti-slide housing 10 with minimal resistance, as the angled surface cams against the interior wall of the housing 10 and deflects elastically until the stopper 55 snaps into registration with the indented area 56. Once seated, the vertical trailing face of the triangular stopper 55 bears against the corresponding wall of the indented area 56 to positively resist forward sliding movement of the mounting bracket 50, thereby locking the garage door opener 70 in place under operational loads.

When intentional removal is desired, the user performs a simple two-step motion: a slight upward lift of the garage door opener 70 and mounting bracket 50 to disengage the stopper 55 from the indented area 56 and clear the mechanical interference, followed by a sliding motion to fully withdraw the mounting bracket 50 and garage door opener 70 from the anti-slide housing 10. This two-step release sequence is intuitive and requires no tools, yet provides sufficient retention force during normal use to prevent inadvertent detachment of the garage door opener 70 from the system.

### Adjustable Strap Member

The adjustable strap member 30 may be configured to secure the assembled system 100 of the present invention to the handlebars of a motorcycle, bicycle, or similar vehicle, thereby providing the primary means of affixing the system to the vehicle.

The term vehicle shall refer broadly to any motorized or non-motorized conveyance having a handlebar or similar elongated gripping member, including without limitation motorcycles, bicycles, scooters, all-terrain vehicles (ATVs), and any other handlebar-equipped vehicle to which the system 100 of the present invention may be operatively attached.

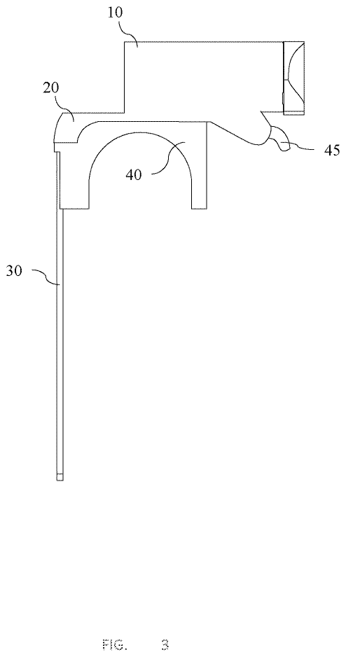

The adjustable strap member 30 may be operatively connected to the mounting base 40, as shown in FIG. 1 and FIG. 3, and may be configured to wrap circumferentially around the handlebar, providing a compressive, frictional grip against the handlebar surface that resists rotational and axial displacement of the system during vehicle operation. The adjustable strap member 30 may act in complementary fashion with the magnetic attachment member 20 and the anti-slide housing 10 to provide a multi-layered retention system 100 that maintains the positional integrity of the mounted garage door opener 70.

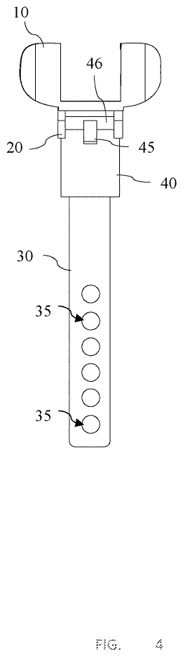

As shown in FIG. 4, the adjustable strap member 30 may extend below the mounting base 40 in the form of a strap or arm, wherein the strap or arm may comprise a plurality of holes 35 disposed along its length. The plurality of holes 35 may be configured to permit selective adjustment of the effective length of the adjustable strap member 30, thereby enabling the system to be secured to handlebars of varying diameters without modification to the structural components of the system.

In one embodiment, the adjustable strap member 30 may be adjustable in length to accommodate a variety of handlebar sizes and configurations.

In one embodiment, the strap member 30 may be fabricated from a resilient rubber or elastomeric material.

### Locking Element

In some embodiments, the mounting base 40 or the magnetic attachment member 20 includes a locking element 45 and a connecting arm 46 configured together to secure the system 100 to a vehicle handlebar. As shown in FIG. 4, the connecting arm 46 can be a rigid or semi-rigid extension that projects laterally from the magnetic attachment member 20, structurally coupling the locking element 45 to the body of the magnetic attachment member 20. The connecting arm 46 serves as the structural bridge that positions the locking element 45 in operative alignment with the adjustment holes 35 defined along the strap member 30.

In some embodiments, the locking element 45 can be disposed at the distal end or in the middle of the connecting arm 46 and may include a resilient, cantilevered tab or clip configured to elastically deflect during installation and spring back to engage a selected one of the adjustment holes 35, thereby securing the assembly at a fixed axial position on the handlebar. The connecting arm 46 may itself exhibit a degree of flexibility, allowing the locking element 45 to be manually depressed for tool-free engagement and disengagement. Together, the connecting arm 46 and locking element 45 form an integrated retention feature that, in cooperation with the plurality of adjustment holes 35 distributed along the strap member 30, accommodates handlebars of varying diameters and provides adjustability in clamping tension without requiring specialized tools.

The system 100 of the present invention may comprise three primary interlocking components: the magnetic attachment member 20, the anti-slide housing 10, and the mounting base 40. The three components may be configured for tool-free assembly, allowing a user to interconnect the components without the need for specialized tools or extensive installation procedures. The tool-free assembly configuration may promote rapid installation and may render the system accessible to a broad range of users regardless of mechanical experience or expertise.

In a preferred embodiment, the three primary components may be configured to interlock seamlessly with one another upon assembly, thereby enhancing the overall structural integrity of the assembled system during vehicle operation.

### Material and Engineering Design

The system (device) 100 of the present invention may be constructed from lightweight yet durable materials, including high-grade plastic or reinforced composite materials, selected for their capacity to provide sufficient structural strength to withstand the mechanical vibrations and impacts associated with vehicle use.

In one embodiment, the components may be manufactured to close tolerances to ensure consistent fitment and reliable interlocking engagement.

Although the invention has been explained in relation to its preferred embodiment, it is to be understood that many other possible modifications and variations can be made without departing from the spirit and scope of the invention.

What is claimed is:

1. A device for mounting a garage door opener on a vehicle handlebar, the device comprising:
a magnetic attachment member comprising one or more neodymium magnets; ;
an anti-slide housing configured to encase the garage door opener and prevent rearward displacement of the garage door opener during vehicle operation; and
a mounting base configured to operatively couple with the magnetic attachment member and to attach to a vehicle handlebar; wherein the magnetic attachment member, the anti-slide housing, and the mounting base are configured to interlock with one another without the use of special tools.

2. The device of claim 1, wherein the magnetic attachment member is configured with adjustable magnet positions to accommodate garage door openers of different sizes.

3. The device of claim 1, wherein the anti-slide housing comprises textured interior surfaces configured to enhance frictional engagement with the garage door opener and minimize slippage thereof.

4. The device of claim 3, wherein the mounting base further comprises a connecting arm extending laterally therefrom and a locking element disposed at an intermediate portion of the connecting arm, the locking element comprising a resilient cantilevered tab configured to elastically deflect during installation and engage a selected one of a plurality of adjustment holes defined along a strap member of the mounting base, thereby securing the device at a fixed position on the vehicle handlebar without the use of special tools.

5. The device of claim 1, wherein the mounting base comprises a U-shaped portion.

6. The device of claim 5, further comprising a mounting bracket attached to the anti-slide housing, the locking mechanism comprising an indentation or groove configured to engage with a clip or latch system to prevent accidental dislodgment of the garage door opener.

7. The device of claim 1, further comprising an adjustable strap member operatively connected to the mounting base and configured to secure the device to a vehicle handlebar, wherein the adjustable strap member is adjustable in length to accommodate handlebars of varying sizes.

8. The device of claim 7, wherein the adjustable strap member comprises a flexible strap including a plurality of holes configured to accommodate handlebars of differing diameters.

9. The device of claim 1, wherein the device is constructed from at least one of high-grade plastic and reinforced composites configured to withstand vibrations and mechanical impacts associated with vehicle operation.

10. A device for mounting a garage door opener on a vehicle handlebar, the device comprising:
a magnetic attachment member comprising one or more neodymium magnets;
an anti-slide housing comprising a unitary, elongated rectangular body having a flat bottom wall, two opposing parallel side walls extending perpendicularly upward from opposing longitudinal edges of the flat bottom wall, and an open top face, the flat bottom wall and the two side walls collectively defining an upwardly open U-shaped channel configured to receive and seat the garage door opener, wherein outer upper corners of the anti-slide housing are chamfered, and wherein the anti-slide housing is configured to straddle and laterally enclose the garage door opener to prevent rearward displacement of the garage door opener;
a mounting base having a U-shaped contoured inner profile configured to receive a vehicle handle bar, the mounting base further incorporating at least one magnet configured to magnetically engage with the magnetic attachment member; and
an adjustable strap member operatively connected to the mounting base and configured to circumferentially wrap around and grip the vehicle handlebar to secure the device thereto; wherein the Magnetic Attachment Member, the anti-slide housing, the mounting base, and the adjustable strap member are configured to interlock with one another without the use of special tools.

11. The device of claim 10, wherein the anti-slide housing comprises textured interior surfaces configured to enhance frictional engagement with the garage door opener and minimize slippage thereof.

12. The device of claim 10, further comprising a mounting bracket configured to be mounted in the anti-slide housing, the mounting bracket includes a locking mechanism comprising an indentation or groove configured to engage with the garage door opener via a clip or latch system to prevent accidental dislodgment of the garage door opener.

13. The device of claim 12, wherein the mounting bracket incorporates a stopper formed as a protruding element on a bottom surface of the mounting bracket, and wherein the anti-slide housing and the magnetic attachment member define a corresponding indented area on an interior surface thereof, such that when the garage door opener fitted with the mounting bracket is inserted into the anti-slide housing, the stopper engages with the indented area to create a mechanical interference fit that resists forward displacement and lateral movement of the garage door opener during vehicle operation, and wherein the stopper and the indented area are configured such that disengagement of the stopper from the indented area requires a lifting force applied to the mounting bracket in a direction perpendicular to the sliding axis, followed by sliding withdrawal of the mounting bracket along the sliding axis.

14. The device of claim 10, wherein the stopper has a triangular cross-sectional profile comprising an inclined leading face configured to guide insertion of the mounting bracket into the anti-slide housing with minimal resistance, and a vertical trailing face configured to bear against a corresponding wall of the indented area to resist forward displacement of the mounting bracket during vehicle operation.

15. The device of claim 14, wherein the adjustable strap member is adjustable in length to fit a variety of handlebar sizes.

16. A device for mounting a garage door opener on a vehicle handlebar, the device comprising:
a magnetic attachment member comprising one or more neodymium magnets;
an anti-slide housing configured to encase the garage door opener and prevent rearward displacement of the garage door opener during vehicle operation;
a mounting base configured to attach to a vehicle handle bar;
a mounting bracket having a U-shaped contoured inner profile configured to receive and secure the garage door opener, the mounting base being configured to replace a back panel of the garage door opener and incorporating at least one magnet configured to magnetically engage with the garage door opener, the mounting bracket further being configured to accommodate a plurality of garage door opener models, the mounting bracket includes an indentation or groove configured to engage with the garage door opener via a clip or latch system to prevent accidental dislodgment of the garage door opener; and
an adjustable strap member operatively connected to the mounting base and configured to circumferentially wrap around and grip a vehicle handlebar, the adjustable strap member comprising a flexible strap including a plurality of holes configured to accommodate handlebars of differing diameters; wherein all components of the device are configured to interlock with one another without the use of special tools.

17. The device of claim 16, wherein the mounting bracket incorporates a stopper formed as a protruding element on a bottom surface of the mounting bracket, and wherein the anti-slide housing and the magnetic attachment member define a corresponding indented area on an interior surface thereof, such that when the garage door opener fitted with the mounting bracket is inserted into the anti-slide housing, the stopper engages with the indented area to create a mechanical interference fit that resists forward displacement and lateral movement of the garage door opener during vehicle operation, and wherein the stopper and the indented area are configured such that disengagement of the stopper from the indented area requires a lifting force applied to the mounting bracket in a direction perpendicular to the sliding axis, followed by sliding withdrawal of the mounting bracket along the sliding axis.

18. The device of claim 17, wherein the mounting bracket further comprises customizable brackets configured to accommodate a wider range of garage door opener designs.

19. The device of claim 16, wherein the magnetic attachment member is configured with adjustable magnet positions to accommodate garage door openers of different sizes.

20. The device of claim 19, wherein the anti-slide housing comprises textured interior surfaces configured to enhance frictional engagement with the garage door opener, and wherein the device is constructed from at least one of high-grade plastic and reinforced composites configured to withstand vibrations and mechanical impacts associated with vehicle operation.
